(19) United States
(12) Patent Application Publication
(10) Pub. No.: US 2019/0122166 A1
(43) Pub. Date: Apr. 25, 2019

(54) SYSTEM FOR INVENTORY MONITORING

(71) Applicant: Walmart Apollo, LLC, Bentonville, AR (US)

(72) Inventors: Andrew Riggins, Fayetteville, AR (US); Steven Lewis, Bentonville, AR (US); Matthew Biermann, Fayetteville, AR (US)

(73) Assignee: Walmart Apollo, LLC, Bentonville, AR (US)

(21) Appl. No.: 16/134,631

(22) Filed: Sep. 18, 2018

Related U.S. Application Data
(60) Provisional application No. 62/574,498, filed on Oct. 19, 2017.

(51) Int. Cl. G06Q 10/08; G01S 17/02; G01S 17/66; G01S 17/88; G06F 9/54

(52) U.S. Cl. CPC G06Q 10/087; G01S 17/026; G06F 9/542; G01S 17/88; G01S 17/66

(57) ABSTRACT

Systems for inventory monitoring are provided. An example system can include: a light source emitting a light beam; an array of semi-reflective surfaces configured to receive the emitted light beam; and a plurality of light sensors corresponding to the array of semi-reflective surfaces, the light sensors configured to receive light beams reflected from the semi-reflective surfaces. The light sensors are positioned with respect to a plurality of corresponding products of the inventory such that the reflected light beams are blocked from receiving by the light sensors when the corresponding products are located in the inventory, and the reflected light beams are received by the light sensors upon removal of the corresponding products.

### BACKGROUND

### 1. Technical Field

The present disclosure relates to a managing system of inventory. More specifically, the present disclosure relates to a system for monitoring inventory.

### 2. Introduction

In retail locations, items that are for users to purchase are usually on display on modular shelves. The items will be restocked from storage or inventory areas when the number of items is reduced to a threshold of inventory level, for example, only two items are remained. The process to manually monitoring the inventory level of items is time-consuming and inconvenient. For example, a store clerk may constantly check the number of the items or a customer may report that no items to be purchased can be located on the shelves, which may incur higher operational costs and decreased customer satisfaction.

Further, items on display at retail locations may be illegally taken off the shelves. For example, popular items may be stolen at a high rate. But manually monitoring of such items, for example, constantly watching a monitoring screen, is not feasible and ineffective.

What is needed are systems for efficiently determining when an item needs to be restocked and for effectively preventing items from being illegally removed.

### SUMMARY

Disclosed herein are systems for inventory monitoring, which overcome at least some drawbacks known in the art. An example system for monitoring an inventory can include: a shelf having a first shelf surface and a second shelf surface opposite thereto; one or more products of the inventory displayed on the first shelf surface; a light source mounted onto the second shelf surface and configured to emit a light beam in a direction corresponding to the displayed one or more products; an array of semi-reflective surfaces mounted onto the second shelf surface in the emitted light beam direction and configured to receive the emitted light beam in a sequential order such that: a first portion of the emitted light is reflected from one semi-reflective surface unto one corresponding product; and a second portion of the emitted light is transmitted through the one semi-reflective surface and received by an immediately following semi-reflective surface; a plurality of light sensors corresponding to the array of semi-reflective surfaces and mounted on the first shelf surface, one light sensor being blocked by one corresponding product such that the light sensors receive the reflected light beams from the semi-reflective surfaces only when the products are removed; and an inventory control unit. The inventory control unit is configured to: control the light source to emit the light beam; receive signals generated from the light sensors and send control signals to the light sensors; control the semi-reflective surfaces to reflect and transmit the light beams; trigger an alarm system when an external object blocks one of the light sensors from receiving the corresponding reflected light beam; send an notification to an external device and update the inventory when products are removed from the shelf, the notification indicative of the number of the removed products; and issue a call to restock the shelf when a threshold of the inventory level is reached.

Another exemplary system for inventory monitoring can include: a light source emitting a light beam; an array of semi-reflective surfaces configured to receive the emitted light beam; and a plurality of light sensors corresponding to the array of semi-reflective surfaces, the light sensors configured to receive light beams reflected from the semi-reflective surfaces. The light sensors are positioned with respect to a plurality of corresponding products of the inventory such that the reflected light beams are blocked from receiving by the light sensors when the corresponding products are located in the inventory, and the reflected light beams are received by the light sensors upon removal of the corresponding products.

Another exemplary system for inventory monitoring can include a light source emitting a light beam; an array of semi-reflective surfaces configured to receive the emitted light beam; and a plurality of light sensors corresponding to the array of semi-reflective surfaces, the light sensors configured to receive light beams reflected from the semi-reflective surfaces. The light sensors are positioned with respect to a plurality of corresponding products of the inventory such that the reflected light beams are blocked from receiving by the light sensors upon reaching by an object into vicinity of the products to trigger an alarm system.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Embodiments of this disclosure are illustrated by way of an example and not limited in the figures of the accompanying drawings, in which like references indicate similar elements and in which:

FIG. 1 illustrates a system of inventory monitoring for deterring illegal removal of products in an inventory according to one example embodiment;

FIG. 2 illustrates a system of inventory monitoring for inventory control according to one example embodiment;

FIG. 3 illustrates a system of inventory monitoring for inventory control according to another example embodiment; and

FIG. 4 illustrates an example computer system which can be used to implement the systems for inventory monitoring.

### DETAILED DESCRIPTION

Various configurations and embodiments of the disclosure are described in detail below. While specific implementations are described, it should be understood that this is done for illustration purposes only. Other components and configurations may be used without parting from the spirit and scope of the disclosure.

The concepts and embodiments described herein are provided to facilitate inventory control at retail stores or other businesses using systems of inventory monitoring. For example, when an item (e.g., product) is removed from a modular shelf and/or purchased by a customer, the system can send a notification indicative of the number of the items and update the level of an inventory accordingly by decreasing the item count. Further, the disclosed systems can facilitate the replenishment of the items. For example, when a threshold of inventory level is reached, the systems can issue a request, for example via an audio or text messaging, to notify a store clerk to restock the modular shelf with the items. The disclosed systems can further prevent the items from being illegally removed from the shelf by triggering an alarm system to deter a person who tries to remove the item from the shelf. The following provides an example system for monitoring an inventory.

The system comprises one or more shelves. These one or more shelves may form a retail shelving system for showcasing products to customers. The shelves can come in any form that may stand on a floor or be mounted onto a wall or a ceiling, such as a modular shelf, a rack, a frame or any other suitable form known in the art. The shelves can also be made of any suitable materials such as wood, plastics, metal, or wires. The shelves can further comprise more than one level having a longitudinal length, a transverse width, and a vertical height, on which products can be on display.

Each level of a shelf can have a first surface (e.g., a bottom surface) and a second surface (a top surface) opposite to the first surface. One or more products of an inventory can be placed for display on the first surface.

The system can further comprise a light source. The light source may be removably disposed on the second surface of one level of the shelf. For example, the light source can be mounted, attached, pinned, or hinged to the second surface via any suitable fixture and/or components (e.g., screws, nuts, nails, or threaded bolts) The light source can be a laser light, a light emitting diode (LED) light, or an infrared light. In some embodiments, the light source may include visible lights, radio waves, microwaves, ultraviolet, or X-rays.

The light source can be configured to emit a light beam in a direction corresponding to the displayed products. For example, when the displayed products are arranged in a linear array in the longitudinal direction of the shelf, the light source can be adjusted to emit a light beam above the products in the longitudinal direction. When the displayed products are arranged in a linear array in the transverse width direction of the shelf, the light source can be adjusted to emit a light beam above the products in the transverse direction. The system can include an array of semi-reflective surfaces for receiving, reflecting, and transmitting the light beam emitted from the light source. The semi-reflective surfaces may be surfaces of beam splitter. As used herein, a beam splitter refers to an optical device that splits an incident light beam in two beams: one beam reflected from the surface of the beam splitter facing the incident beam, and another beam transmitted through the beam splitter and travelling along the direction of the incident beam. The beam splitter may be made of a glass, a plexiglass, a birefringent material, a half-silvered mirror, a dichroic optical coating, or a plastic with a transparently thin coating of metal. The semi-reflective surfaces may be removably disposed on the second surface of one level of the shelf. For example, the semi-reflective surfaces can be mounted, attached, pinned, or hinged to the second surface via any suitable fixture and/or components (e.g., screws, nuts, nails, or threaded bolts).

The semi-reflective surfaces can be arranged to receive the light beam emitted from the light source in a sequential order, and each may correspond to one product displayed on the first surface of the shelf level. For example, the light beam emitted from the light source first arrives at a first semi-reflective surface, the first semi-reflective surface then reflects a portion of the emitted light beam and directs the reflected light beam toward one corresponding product, and another portion (e.g., a remaining portion) of the emitted light is transmitted through the first semi-reflective surface. The light beam transmitted through the first semi-reflective surface arrives at the second semi-reflective surface that immediately follows the first semi-reflective surface. A portion of the transmitted light beam is reflected by the second semi-reflective surface that directs towards one product corresponding to the second semi-reflective surface, and another portion (e.g., a remaining portion) of the transmitted light beam is transmitted through the second semi-reflective surface and directs to the third semi-reflective surface of the array of semi-reflective surfaces, and so on.

The semi-reflective surfaces can be arranged in a linear or nonlinear form. For example, the semi-reflective surfaces can be arranged in a pattern of square, triangle, or any polygon regardless of the arranged pattern of the products, so long as one semi-reflective surface corresponds to one product.

The system can further comprise a plurality light sensors for receiving light beams reflected from the semi-reflective surfaces. The light sensors can be removably attached, affixed, mounted, or in any other suitable manner to the first surface of the shelf level with respect to the products displayed on the first surface, in such a way that one product would block one light sensor from receiving a corresponding reflected light beam when the one product is positioned on the first surface. When the one product is removed from the shelf, the corresponding light sensor is able to receive a light beam reflected from a corresponding semi-reflective surface. For example, the light sensors may be placed beneath the corresponding products. As a result, when a product is removed or purchased from the shelf, the system can detect the nonexistence of the product in its slot of the shelf by receiving a signal from the corresponding light sensor indicative of receiving a reflected light beam. Consequently, the system can track the number of products and automatically monitor the inventory level of the products. For example, the system may decrement the product count for that slot, and notify a store associate or clerk to restock or verify inventory when the product count reaches a specified threshold (i.e., a low inventory level).

The light sensors can be a photoconductive device, a photovoltaic cell, a photodiode, or a phototransistor. As used herein, a photoconductive device refers to a device for measuring the resistance by converting a change of incident light into a change of resistance. A photovoltaic cell refers to a device for converting an amount of incident light into an output voltage. A photodiodes refers to a device for converting an amount of incident light into an output current. A phototransistor refers to a type of bipolar transistor in which the base-collector junction is exposed to light.

As explained above, the light beam emitted by the light source is transmitted through the semi-reflective surfaces in a sequential order. As such, the resulting light intensity received by the subsequent semi-reflective surfaces may be reduced significantly such that the corresponding light sensors may not respond well to the reflected light beams. In such cases, the system can include optical amplifiers to enhance the light intensities of transmitted light beams and/or reflected light beams. The optical amplifier can be a laser amplifier including solid-state amplifiers and doped fibre amplifiers, a semiconductor optical amplifier, a Raman amplifier, or a parametric amplifier. As used herein, a laser amplifier refers to an optical amplifier for enhancing the incoming light via stimulated emission in the amplifier's gain medium. A semiconductor optical amplifier refers to an optical amplifier using a semiconductor to provide the gain medium involving electron-hole recombination. A Raman amplifier refers to an optical amplifier to intensify the incident light by Raman amplification. A parametric amplifier refers to an optical amplifier for amplifying a weak light in a noncentrosymmetric nonlinear medium. In some embodiments, the light sensor can also be adjusted or adjust itself accordingly to adapt to a weak incoming reflected light beam.

In some situations, the system can also be used to deter illegal removal of products from the shelf. For example, when a person reaches into the shelf to remove a product in a manner not consistent with the store's product removal procedure, the corresponding light sensor may detect the reflected light beam due to the removal of the product. In addition to or in the alternative, the sensors may be blocked from receiving the reflected light beam due to an external object (e.g., a hand or an arm of the person) that breaks the reflected light beam. The system can detect such light sensor signal change pattern to determine that a removal of the product (e.g., theft) occurs.

The system can further comprise an alarm system or unit for deterring a person who removes a product illegally from the shelf. For example, when the system detects a light sensor signal change indicative of that removal of the product (e.g., theft) is occurring, the system can trigger the alarm unit, for example sounding the alarm or siren a noise to store personnel, to deter the person. The alarm unit can be an existing alarm system external to the system. As used herein, the alarming unit refers to an alarming unit for detecting unauthorized entry into a building or a specific area (e.g., the shelf herein) by giving an audible, visual or other form of alarm signal, and may comprise a siren, a monitoring screen, a control panel, and/or other parts/components known in the art.

In some embodiments where the system is used for deterring an illegal removal of products from the shelf, the light source, the array of semi-reflective surfaces, and the array of light sensors corresponding to the semi-reflective surfaces can be arranged in a way such that the light sensors are able to continually receive the reflected light beams until an object breaks the reflected light beams. For example, the light source and the semi-reflective surfaces can be disposed on a front edge of the second surface of the shelf level, and the light sensors can be disposed on a corresponding front edge of the first surface of the shelf level, so no products are placed between the semi-reflective surfaces and the light sensors. Thus, the light sensors continually receive the light beams reflected from corresponding semi-reflective surfaces. When a person reaches into the shelf from the front of the shelf to try to remove products from the shelf, the corresponding reflected light beam is broken by the person's hand or arm, and the corresponding light sensor would not receive the reflected light beam. Upon detecting the broken light beam (e.g., no signal is received from the light sensor by the system), the system can trigger the alarm unit.

The system can also comprise a notification unit configured to notify store associate or clerk of a low level of inventory of the product and/or removal of a product from the shelf via, for example, messaging to a mobile device (e.g., a smartphone) carried by the store associate. The notification message may also be sent to a screen monitor associated with a store management system. In such way, the inventory level of the product can be adjusted and the products can be replenished if necessary. Also upon receiving a message regarding removal of products from the shelf, a store associate may come to the shelf to check the products and verify whether the products have been purchased or illegally removed. As used herein, the notification unit refers to a notification unit combining software and hardware that provides a means of delivering a message to one or more recipients, as known in the art. The term “mobile device” shall be construed to mean any portable electronic device with a display and communication capabilities, including a mobile phone, cellular phone, smart phone, tablet computer, laptop computer, personal digital assistant, portable computing device, navigation system, navigator, and so forth.

The system can further comprise a control unit configured to control the light source to email a light beam, receive signals generated from the light sensors and send control signals to the light sensors, control the semi-reflective surfaces to reflect and transmit light beams, trigger the alarm system when an external object blocks one of the light sensors from receiving the corresponding reflected light beam, send an notification to an external device and update the inventory when products are removed from the modular shelf, and issue a call to restock the modular shelf when a threshold of the inventory level is reached. The control unit can embodiment software, hardware, and/or a combination thereof. For example, the control unit can be a computer system having application software thereon.

For purposes of this disclosure, the terms “retail store,” “business,” and can be used interchangeably and shall be construed to mean an organization that sells goods to one or more buyers or customers. Some examples of “business” can include, but not limited to, a retail store, a retailer, a market, a supermarket, a wholesale merchant, a distributor, a dealership, and so forth. Furthermore, for purposes of this disclosure, the terms “product”, “goods” and “item” can be used interchangeably and shall be construed to mean tangible products, commodity, or merchandise that are a subject for sale from a business to a customer. The term “inventory” shall be construed to mean a plurality of goods.

Various embodiments, implementations, and examples will be further described as the illustrations of the disclosure are described in detail below. While specific implementations are described, it should be understood that this is done for illustration purposes only. Other components and configurations may be used without parting from the spirit and scope of the disclosure. In addition, components, steps, and features described may be removed, added, or combined from the provided examples.

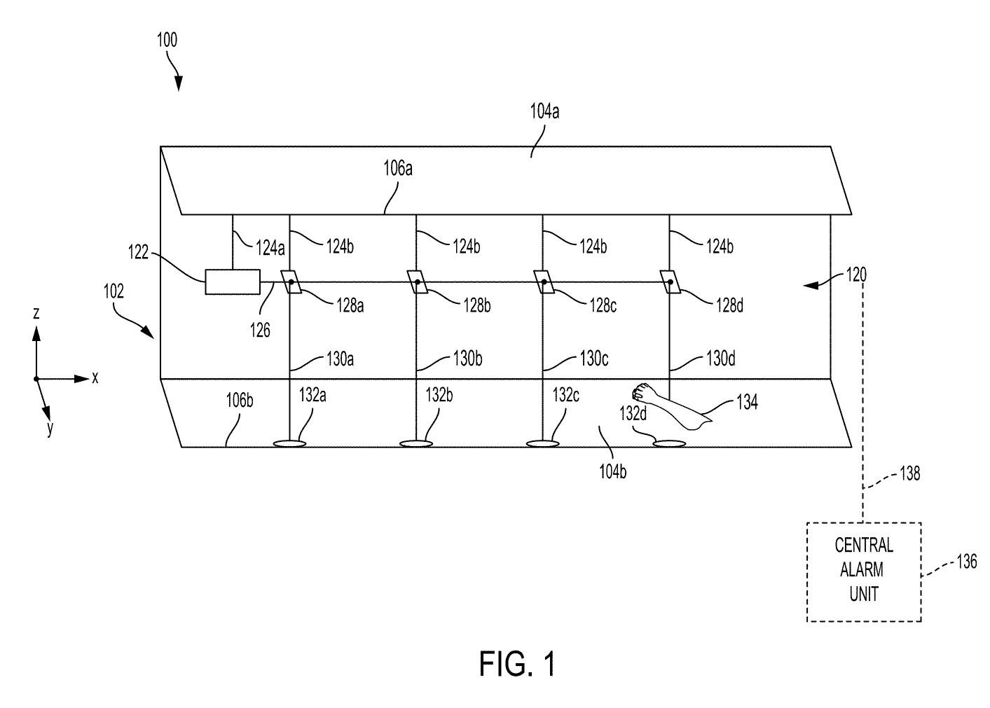

FIG. 1 illustrates a system 100 according to one example embodiment. In the system 100, only one shelf level 102 is shown for simplicity. As appreciated by persons skilled in the art, as many shelf levels as desired can be provided for a shelf in the vertical z direction, for example by stacking the shelf level 102. As shown in FIG. 1, the shelf level 102 can be constructed with a shelf top surface 104a and a shelf bottom surface 104b, and has a longitudinal length in the x direction and a transverse width in the y direction. The shelf level 102 can further include a top front edge 106a and a bottom front edge 106b. A plurality of products (not shown in FIG. 1) may be on display in any desirable arrangement on the shelf bottom surface 104b for purchase and/or storage.

An inventory monitoring unit 120 can be installed between the shelf top surface 104a and the shelf bottom surface 104b. The unit 120 may include a light source 122 (e.g. a laser) that is mounted to the top front edge 106a via a mounting fixture 124a and is configured via a control unit (not shown) to emit a light beam 126 along the longitudinal length of the shelf 102. The mounting fixture 124a is configured to fix the light source 122 removably onto the top front edge 106a and/or the shelf top surface 104a, and may comprise a metal or plastic bar, screws, hinges, nuts, threaded blots, and the like.

The inventory monitoring unit 120 can also include an array of semi-reflective surfaces 128 that are removably fixed via the mounting fixtures 124b to the top front edge 106a and/or the shelf top surface 104a. As the mounting fixture 124a, the mounting fixture 124b may comprise a metal or plastic bar, screws, hinges, nuts, threaded blots, and the like. The array of semi-reflective surfaces are arranged in a way that they are positioned and aligned along the path of the emitting light beam 126, such that a first portion of the emitting light beam 126 is transmitted sequentially through the array of semi-reflective surfaces and a second portion of the emitting light beam 126 is reflected as reflected light beams 130 directing toward the shelf bottom surface 104b and/or the bottom front edge 106b.

The inventory monitoring unit 120 can further include a plurality of light sensors 132. The light sensors may be arranged in a way that they each correspond to one of the semi-reflective surfaces 128 and receive the reflected light beam 130 from the corresponding semi-reflective surface. The light sensors 132 can be attached removably via a mounting fixture (not shown in FIG. 1) to the bottom front edge 106b and/or the shelf bottom surface 104b. The mounting fixture here, like the mounting fixture 124, may comprise a metal or plastic bar, screws, hinges, nuts, threaded blots, and the like. The light sensors are configured to send signals to and receive signals from the control unit, and can be controlled by the control unit.

When an external object, such as a hand and arm 134, reach into the shelf 102 from front of the shelf 102 for, for example removing a product illegally, one or more reflected light beams 130 can be broken, that is, the corresponding light sensors 132 does not receive the reflected light beams 130. Upon detecting by the sensor the broken light beams, the control unit may receive a signal from the light sensor and determines that an illegal entry into the shelf occurs. Further the system 100 may communicate to an external central alarming unit 136, as indicated by a dotted line 138. Upon determination of an illegal entry into the shelf, the system 100 can, via the control unit, trigger the alarming unit 136, for example sound a siren, to deter the person from illegally removing the products from the shelf 102 or send a notice a store personnel.

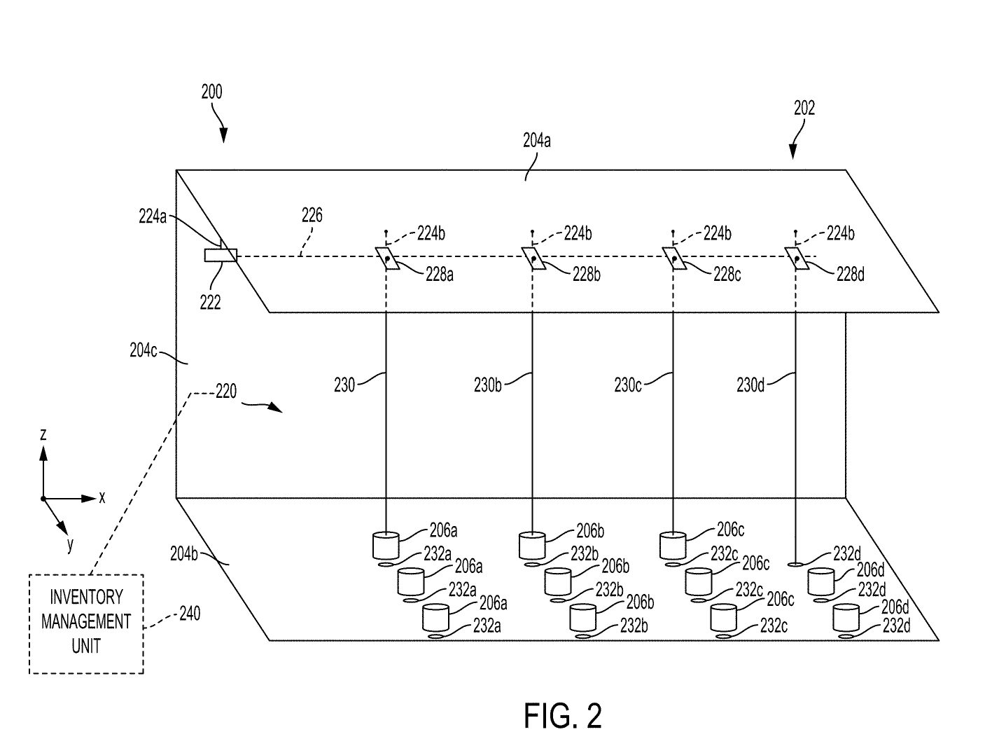

FIG. 2 shows a system 200 of inventory monitoring for inventory level control according to one example embodiment. In the system 200, only one shelf level 202 is shown for simplicity. As appreciated by persons skilled in the art, as many shelf levels as desired can be provided for a shelf in the vertical z direction, for example by stacking the shelf level 202. As shown in FIG. 2, the shelf level 202 can be constructed with a shelf top surface 204a, a shelf bottom surface 204b, and a shelf back surface 204c, and has a longitudinal length in the x direction and a transverse width in the y direction. The shelf level 202 may be mounted to a wall via the shelf back surface 204c in a retail store, or may just put up on a store floor. A plurality of products 206 may be on display in any desirable arrangement on the shelf bottom surface 204b for purchase and/or storage.

An inventory monitoring unit 220 can be installed between the shelf top surface 204a and the shelf bottom surface 204b. The unit 220 may include a light source 222 (e.g. a laser) that is mounted to the shelf top surface 204a via a mounting fixture 224a and is configured via a control unit (not shown) to emit a light beam 226 along the longitudinal length of the shelf 202. The mounting fixture 224a is configured to fix the light source 222 removably onto the shelf top surface 204a, and may comprise a metal or plastic bar, screws, hinges, nuts, threaded blots, and the like. The light source 222 can be installed anywhere along the transverse width such that the emitted light beam 226 can align with the products in the longitudinal length.

The inventory monitoring unit 120 can also include an array of semi-reflective surfaces 228 that are removably fixed via the mounting fixtures 224b to the shelf top surface 204a along the longitudinal length. As with the mounting fixture 224a, the mounting fixture 224b may comprise a metal or plastic bar, screws, hinges, nuts, threaded blots, and the like. The array of semi-reflective surfaces 228 are arranged in a way that they are positioned and aligned along the path of the emitting light beam 226, such that a first portion of the emitting light beam 226 is transmitted sequentially through the array of semi-reflective surfaces and a second portion of the emitting light beam 226 is reflected as reflected light beams 230 directing toward the products 206 on the shelf bottom surface 204b.

The inventory monitoring unit 220 can further include a plurality of light sensors 232. The light sensors 232 are arranged in a way that they each corresponds to one of the semi-reflective surfaces 228 and one of the products 206. Further, the light sensors 232 are positioned with respect to the plurality of products 206 of the inventory such that the reflected light beams 230 are blocked from receiving by the light sensors 232 when the corresponding products remain on the shelf 202 in the inventory, and the reflected light beams 230 are received by the light sensors 232 upon removal of the corresponding products 206 from the shelf 202. For example, as shown in FIG. 2, the light sensors 232 may be positioned beneath the products 206. One light sensor is blocked by one corresponding product such that the light sensors receive the reflected light beams from the semi-reflective surfaces only when the products are removed. In other embodiments, not every product is required to have a corresponding sensor and/or reflective surface. The system can interpret product removals to monitor inventory levels.

The light sensors 232 can be attached removably via a mounting fixture (not shown in Fig.) to the shelf bottom surface 204b. The mounting fixture here, like the mounting fixture 224, may comprise a metal or plastic bar, screws, hinges, nuts, threaded blots, and the like. The light sensors 232 are configured to send signals to and receive signals from the control unit, and can be controlled by the control unit.

When a product is removed from the shelf, for example, one of the products 206d is purchased by a customer, the light sensor 232d corresponding to the product 206d is exposed and is able to receive the reflected light beam 230d. Upon sensing the reflected light beam, the control unit may receive a signal from the light sensor and determine that there is not product in that slot. In such way, the system 200 can track the count of the products and adjust the inventory accordingly. For example, the system 200 can decrease the product count when that product is removed from the shelf and notify a store associate to restock or verify inventory.

Further the signal may be sent, directly or via a communications network, to an inventory management unit 240. The inventory management unit 240 may include one or more inventory databases associated with the products 206 for further inventory management, such as, automatically or manually updating when the products are sold or replenished, in place of or in addition to the control unit performing these tasks.

Further, although only one light source and corresponding semi-reflective surfaces and light sensors are shown in FIG. 2 and described herein, any desired number of light sources and corresponding semi-reflective surfaces and light sensors can be added along the transverse width direction to accommodate the number of products.

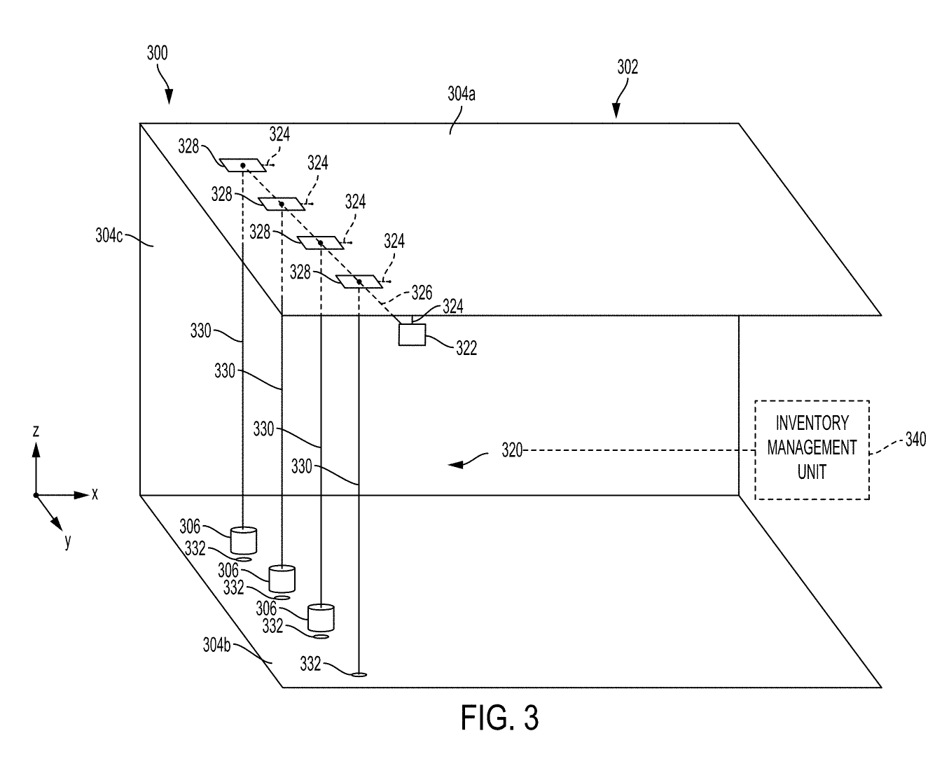

FIG. 3 illustrates a system 300 of inventory monitoring for inventory level control according to another example embodiment. In the system 300, only one shelf level 302 is shown for simplicity. As appreciated by persons skilled in the art, as many shelf levels as desired can be constructed for a shelf in the vertical z direction, for example by stacking the shelf level 302. As shown in FIG. 3, the shelf level 302 can be constructed with a shelf top surface 304a, a shelf bottom surface 304b, and a shelf back surface 304c, and has a longitudinal length in the x direction and a transverse width in the y direction. The shelf level 302 may be mounted to a wall via the shelf back surface 304c in a retail store, or may just put up on a store floor. A plurality of products 306 may be on display in any desirable arrangement on the shelf bottom surface 304b for purchase and/or storage.

An inventory monitoring unit 320 can be installed between the shelf top surface 304a and the shelf bottom surface 304b. The unit 320 may include a light source 322 (e.g. a laser) that is mounted to the shelf top surface 304a via a mounting fixture 324 and is configured via a control unit (not shown) to emit a light beam 326 along the transverse width of the shelf 302. The mounting fixture 324 is configured to fix the light source 322 removably onto the shelf top surface 304, and may comprise a metal or plastic bar, screws, hinges, nuts, threaded blots, and the like. The light source 322 can be installed anywhere along the longitudinal length such that the emitted light beam 326 can align with the products in the transverse width.

The inventory monitoring unit 320 can also include an array of semi-reflective surfaces 328 that are removably fixed via the mounting fixtures 324 to the shelf top surface 304a along the transverse width. The array of semi-reflective surfaces 328 are arranged in a way that they are positioned and aligned along the path of the emitting light beam 326, such that a first portion of the emitting light beam 326 is transmitted sequentially through the array of semi-reflective surfaces and a second portion of the emitting light beam 326 is reflected as reflected light beams 330 directing toward the products 306 on the shelf bottom surface 304b.

The inventory monitoring unit 320 can further include a plurality of light sensors 332. The light sensors 332 are arranged in a way that they each corresponds to one of the semi-reflective surfaces 328 and one of the products 306. Further, the light sensors 332 are positioned with respect to the plurality of products 306 of the inventory such that the reflected light beams 330 are blocked from receiving by the light sensors 332 when the corresponding products remain on the shelf 302 in the inventory, and the reflected light beams 330 are received by the light sensors 332 upon removal of the corresponding products 306 from the shelf 302. For example, as shown in FIG. 3, the light sensors 332 may be positioned beneath the products 306. One light sensor is blocked by one corresponding product such that the light sensors receive the reflected light beams from the semi-reflective surfaces only when the products are removed.

The light sensors 332 can be attached removably via a mounting fixture (not shown in FIG. 3) to the shelf bottom surface 304b. The mounting fixture here, like the mounting fixture 324, may comprise a metal or plastic bar, screws, hinges, nuts, threaded blots, and the like. The light sensors 332 are configured to send signals to and receive signals from the control unit, and can be controlled by the control unit.

When a product is removed from the shelf, for example, one of the products 306 is purchased by a customer, the light sensor 332 corresponding to the product 306 is exposed and is able to receive the reflected light beam 330. Upon sensing the reflected light beam, the control unit may receive a signal from the light sensor and determines that there is not product in that slot. In such way, the system 300 can track the count of the products and adjust the inventory accordingly. For example, the system 300 can decrease the product count when that product is removed from the shelf and notify a store associate to restock or verify inventory.

Further the system 300 may communicate, directly or via a communications network, to an external inventory management unit 340. The inventory management unit 340 may include one or more inventory databases associated with the products 306 for further inventory management, such as, automatically or manually updating when the products are sold or replenished.

Further, although only one light source and corresponding semi-reflective surfaces and light sensors are shown in FIG. 3 and described herein, any desired number of light sources and corresponding semi-reflective surfaces and light sensors can be added along the longitudinal direction to accommodate the number of products.

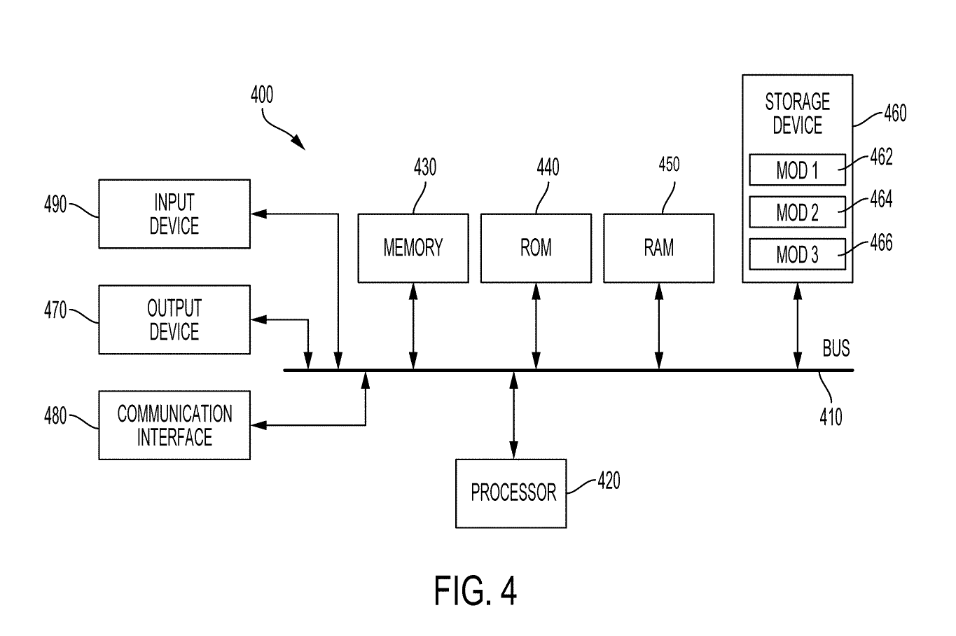

FIG. 4 illustrates an example computer system 400 which can be used to perform the systems for inventory monitoring as disclosed herein. The exemplary system 400 can include a processing unit (CPU or processor) 420 and a system bus 410 that couples various system components including the system memory 430 such as read only memory (ROM) 440 and random access memory (RAM) 450 to the processor 420. The system 400 can include a cache of high speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A system for monitoring an inventory, comprising:
a shelf having a first shelf surface and a second shelf surface opposite thereto;
one or more products of the inventory displayed on the first shelf surface;
a light source mounted onto the second shelf surface and configured to emit a light beam in a direction corresponding to the displayed one or more products;
an array of semi-reflective surfaces mounted onto the second shelf surface in the emitted light beam direction and configured to receive the emitted light beam in a sequential order such that: a first portion of the emitted light is reflected from one semi-reflective surface unto one corresponding product; and a second portion of the emitted light is transmitted through the one semi-reflective surface and received by an immediately following semi-reflective surface;
a plurality of light sensors corresponding to the array of semi-reflective surfaces and mounted on the first shelf surface, one light sensor being blocked by one corresponding product such that the light sensors receive the reflected light beams from the semi-reflective surfaces only when the products are removed; and
an inventory control unit, the inventory control unit configured to:
control the light source to emit the light beam;
receive signals generated from the light sensors and send control signals to the light sensors;
control the semi-reflective surfaces to reflect and transmit the light beams;
trigger an alarm system when an external object blocks one of the light sensors from receiving the corresponding reflected light beam;
send an notification to an external device and update the inventory when products are removed from the shelf, the notification indicative of the number of the removed products; and
issue a call to restock the shelf when a threshold of the inventory level is reached.

2. The system of claim 1, wherein the light source is one of a laser light or an infrared light.

3. The system of claim 1, wherein the semi-reflective surfaces are configured to form a linear array.

4. The system of claim 1, wherein the semi-reflective surfaces are configured to forma a nonlinear array.

5. The system of claim 1, wherein the semi-reflective is a surface of a beam splitter made of at least one of a glass, a plexiglass, a birefringent material, a half-silvered mirror, a dichroic optical coating, or a plastic with a transparently thin coating of metal.

6. The system of claim 1, wherein the light sensor is one of a photoconductive device, a photovoltaic cell, or a photodiode.

7. A system for monitoring an inventory, comprising:
a light source emitting a light beam;
an array of semi-reflective surfaces configured to receive the emitted light beam; and a plurality of light sensors corresponding to the array of semi-reflective surfaces, the light sensors configured to receive light beams reflected from the semi-reflective surfaces,
wherein the light sensors are positioned with respect to a plurality of corresponding products of the inventory such that the reflected light beams are blocked from receiving by the light sensors when the corresponding products are located in the inventory, and the reflected light beams are received by the light sensors upon removal of the corresponding products.

8. The system of claim 7, wherein the light source is one of a laser light or an infrared light.

9. The system of claim 7, wherein the semi-reflective surfaces are configured to form a linear array.

10. The system of claim 7, wherein the semi-reflective surfaces are configured to forma a nonlinear array.

11. The system of claim 7, wherein the semi-reflective is a surface of a beam splitter made of at least one of a glass, a plexiglass, a birefringent material, a half-silvered mirror, a dichroic optical coating, or a plastic with a transparently thin coating of metal.

12. The system of claim 7, wherein the light sensor is one of a photoconductive device, a photovoltaic cell, or a photodiode.

13. The system of claim 7, further comprising a control unit configured to control the light source and the light sensors.

14. The system of claim 7, further comprising a notification unit configured to send a notification indicative of a low level of the inventory.

15. The system of claim 7, further comprising one or more optical amplifiers configured to amplify at least one of the reflected light beams and the emitted light beam.

16. The system of claim 7, wherein the light sensors are configured to adapt to a light intensity of the reflected light beams.

17. A system for monitoring an inventory, comprising:
a light source emitting a light beam;
an array of semi-reflective surfaces configured to receive the emitted light beam; and
a plurality of light sensors corresponding to the array of semi-reflective surfaces, the light sensors configured to receive light beams reflected from the semi-reflective surfaces,
wherein the light sensors are positioned with respect to a plurality of corresponding products of the inventory such that the reflected light beams are blocked from receiving by the light sensors upon reaching by an object into vicinity of the products to trigger an alarm system.

18. The system of claim 17, further comprising a control unit configured to control the light source and the light sensors and to trigger the alarming system.

19. The system of claim 17, further comprising a notification unit configured to send a notification indicative of the reaching by the object.

20. The system of claim 17, further comprising one or more optical amplifiers configured to amplify at least one of the reflected light beams and the emitted light beam.
